(19) United States
(12) Patent Application Publication
(10) Pub. No.: US 2006/0277917 A1
(43) Pub. Date: Dec. 14, 2006

(54) Thermochemical water splitting power generation process and system

(76) Inventor: Kuai-Teng Hsu, Clarksville, MD (US)

Correspondence Address: Kuai-Teng Hsu, 7371 Hallmark Road, Clarksville, MD, 21029, US

(21) Appl. No.: 11/148,935

(22) Filed: Jun. 9, 2005

(51) Int. Cl. F02C 3/30; F02C 7/00

(52) U.S. Cl. 60/775; 60/39.53

(57) ABSTRACT

A process and system of power generation utilizes the instantaneous combustion nature of hydrogen and oxygen in a combustion chamber to generate heat, of which hydrogen is generated by splitting water through thermochemical reaction process. The heat generated in combustion chamber is used to heat the water in boiling chamber surrounding the combustion chamber so as to produce steam vapor for outputting as a kind of power source, which can be used to drive any conventional steam driven power generation device to produce electricity as well as mechanical power. The combustion chamber is formed around the reaction chamber, such that portion of the heat generated in the combustion chamber can be imparted to reaction chamber to sustain the thermochemical reaction for continuous hydrogen production. Throughout this power generation process and system, water being condensed or regenerated is recycled back into the process and no harmful byproducts are produced.

### BACKGROUND OF INVENTION

1. Field of Invention

This invention relates to a power generation process and system driven by heat generated through instantaneous hydrogen-oxygen combustion. The hydrogen produced by the thermochemical water splitting process and the steam required for the steam driven generator use water as the raw material, which is abundant, renewable and environmental friendly. The oxygen required in hydrogen-oxygen combustion is taken from the air.

2. Prior Art

Currently, the primary sources of energy are fossil fuels, hydropower and nuclear fission. To a lesser degree, wind power, geothermal power and hydrogen fuel also provide energy.

Fossil fuels primarily consist of oil and coal. Both oil and coal are non-renewable resources. Due to the global economic and industrial development, these resources are depleting to an alarming level and may run out in the near future. In addition, the drilling, mining and refining of oil and coal can cause significant damage to the environment. Furthermore, greenhouse gases and other harmful pollutants are emitted when fossil fuels are burned, causing environmental hazard and health risks.

Hydroelectric power derives its energy by converting the potential energy of flowing river water into kinetic energy to drive turbines that produce electricity. Hydroelectric power emits neither health-threatening chemical effluents nor greenhouse gases emitted from fossil fuel power generating process, however, it requires the construction of dams across rivers and lakes that cause changes in local ecology and surrounding landscapes. In addition, hydroelectric power's initial construction costs are high and feasible sites for large dams are limited. Furthermore, dams are vulnerable to natural forces such as earthquakes. The event of dam failure may result in significant loss of human life and high property damage.

Nuclear fission can deliver power cleanly and reliably on a massive scale. However, the danger of a core meltdown, the health risk of exposing public and plants' employees to radiation from accidents, and the cost of security threats to reactors, reprocessing plants, nuclear waste repositories and waste transport outweigh the benefits.

Wind power is a renewable source of energy. Wind turbines on mountain ridges, passes, and coastlines convert kinetic energy from wind into electricity. The cost of wind power generation is generally higher than fossil fuel. The rate of power generation depends upon daily and seasonal weather. The aesthetic intrusion of the towers and the wildlife killed by the wind blades are other drawbacks.

Solar energy derives its energy from the heat of sunlight. Although heat energy from sun is almost inexhaustible, it is not reliable due to its low heat intensity and its dependence on daily and seasonal weather. Furthermore, solar energy must be collected through the very large solar panels, which use large volumes of nonrenewable materials in their construction; this results in higher energy costs and waste byproducts.

Geothermal power draws its energy from heat and pressure of the underground geothermal reservoir. Unlike the wind power and solar energy, its operation does not depend on daily and seasonal weather. Its operation also does not emit environmental harmful agents. Geothermal energy's environmental impact is primary limited to drilling and construction. Due to its high initial construction cost and the fact that the intensity of heat and pressure extracted is usually not very high, geothermal power in general is not cost effective when compared with the fossil fuels.

Hydrogen is the lightest element and has the highest energy content per unit weight of any known fuel. In addition, hydrogen emits neither ecological nor environmentally harmful agents into the atmosphere when it combusts with oxygen. As a result, hydrogen energy becomes the most viable alterative to fossil fuel energy. However, about 95% of the hydrogen we use today comes from reforming natural gas, which is limited in quantity. The remainder, high purity hydrogen from water electrolysis, is produced using electricity mainly generated by burning fossil fuels and is thus not cost effective. Furthermore, current hydrogen production methods dictate that hydrogen be distributed to its end users by pipeline, which requires the construction of an extensive infrastructure, or by road via cylinders, tube trailers, and cryogenic tankers in small quantity. Accordingly, a better method of hydrogen power generation process and system is required to satisfy the global need for a reliable, renewable, portable and environmentally friendly energy sources.

Objects and Advantages

The main object of the invention is to create a self-contained and self-sustained power generation process and system that uses water as its raw material to produce hydrogen as fuel. The hydrogen-oxygen combustion generates heat that can be used to generate steam that drives turbines for generating electricity and other mechanical power.

Another object of the invention is to create a power generation process and system that uses water as its raw material, which is cheap and abundant and requires no special processes to extract and produce it.

Another object of the invention is to create a power generation process and system that uses water as its raw material that can be delivered with the existing infrastructure.

Another object of the invention is to create a power generation process and system that uses water as its raw material, which is inert, stable and nonflammable.

Another object of the invention is to create a power generation process and system that utilizes the oxygen in the atmosphere for hydrogen-oxygen combustion that will simplify the thermochemical water splitting process.

Another object of the invention is to create a power generation process and system that utilizes the oxygen in atmosphere for hydrogen combustion and thereby eliminating the additional heat required to extract oxygen in thermochemical water-splitting process.

Another object of the invention is to create a power generation process and system, wherein catalysts are added to enhance the efficiency of thermochemical process for hydrogen production.

Another object of the invention is to create a power generation process and system, wherein catalysts are retained and reused in the thermochemical reaction chamber, such that the cost of hydrogen production is minimized.

Another object of the invention is to create a power generation process and system, wherein catalysts are retained in the thermochemical reaction chamber to eliminate the need of redeployment of catalysts.

Another object of the invention is to create a power generation process and system, wherein conventional steam turbines and engines can be retrofitted with the present invention.

Another object of the invention is to create a power generation process and system, wherein no environmentally harmful effluents are emitted.

Another object of the invention is to create a power generation process and system that produces no harmful effluents and thus eliminating the need of waste purging system.

Another object of the invention is to create a power generation process and system, wherein hydrogen gas production and combustion are contained in a single system to eliminate the need and the cost of hydrogen delivery.

Another object of the invention is to create a power generation process and system that requires only a small amount of heat to initiate the thermochemical process to produce a massive amount of heat, such that the process can be self-sustained indefinitely to produce a massive amount of energy.

Another object of the invention is to create a power generation process and system in which the sizes of the system unit are flexible to meet various industry applications.

Another object of the invention is to create a power generation process and system, wherein the water formed by the hydrogen-oxygen combustion is recycled as the raw material for hydrogen production to minimize material cost.

Another object of the invention is to create a power generation process and system, wherein the steam used to drive the steam turbine is collected, reheated and recycled back to drive the steam turbine to generate power, so that the water consumption is minimized.

Another object of the invention is to create a power generation process and system, wherein the heat generated is substantially higher than the conventional fossil fuel burning processes.

Another object of the invention is to create a power generation process and system, wherein the thermochemical reaction chamber and the combustion chamber are coated with an enamel porcelain material to withstand the acidic content in the water and high temperatures in the reaction and combustion chambers.

Another object of the invention is to create a power generation process and system, wherein perforated tubing coils are used for the hydrogen and air distribution systems in combustion chamber to distribute hydrogen and air evenly, resulting in instantaneous hydrogen-oxygen combustion.

Another object of the invention is to create a power generation process and system, wherein the hydrogen and air distribution coils are coated with an enamel porcelain material to withstand the high temperature in the combustion chamber.

Further objects and advantages will become apparent through consideration of the ensuing description and drawings.

### SUMMARY

In order to accomplish the above objects, the present invention provides a process of power generation, comprising the following steps:
(1) splitting the water by thermochemical reaction in reaction chamber to produce hydrogen;
(2) transferring hydrogen into a combustion chamber, wherein the hydrogen combusts with the oxygen in the air instantaneously;
(3) transferring a portion of the heat to the reaction chamber to facilitate a continuous thermochemical reaction for hydrogen production while using a major portion of the heat to heat water in the boiling chamber for steam production; and
(4) utilizing the steam to drive steam turbines to generate electricity or to drive other steam driven devices that generate mechanical power.

The present invention also provides water recovery devices to recover and reuse the water produced from hydrogen-oxygen combustion and from the steam turbine.

### DRAWINGS—FIGURES

FIG. 1A is a flow chart illustrating a process of power generation according to the preferred embodiment of the present invention.

FIG. 1B is a flow chart illustrating the substeps of splitting water to produce hydrogen for power generation according to the preferred embodiment.

FIG. 2A is a top view of the conceptual power generation system according to the preferred embodiment of the present invention. (For clarity, coils for hydrogen and air distribution in combustion chamber are not shown).

FIG. 2B is a vertical sectional view of the conceptual power generation system according to the preferred embodiment of the present invention.

### REFERENCE NUMERALS

11 reaction chamber 12 combustion chamber 13 boiling chamber 14 water recovery pan 21 water inlet for reaction chamber 22 water inlet for boiling chamber 23 steam outlet from boiling chamber to steam driven power generator 24 hydrogen delivery tube from reaction chamber to combustion chamber 25 water/steam recycle tube from steam driven power generator to boiling chamber 26 air inlet 27 initial hydrogen inlet 28 drain hole at the bottom of combustion chamber 31 hydrogen distribution coil in combustion chamber 32 air distribution coil in combustion chamber 40 steam driven power generator

### DETAILED DESCRIPTION—PREFERRED EMBODIMENT

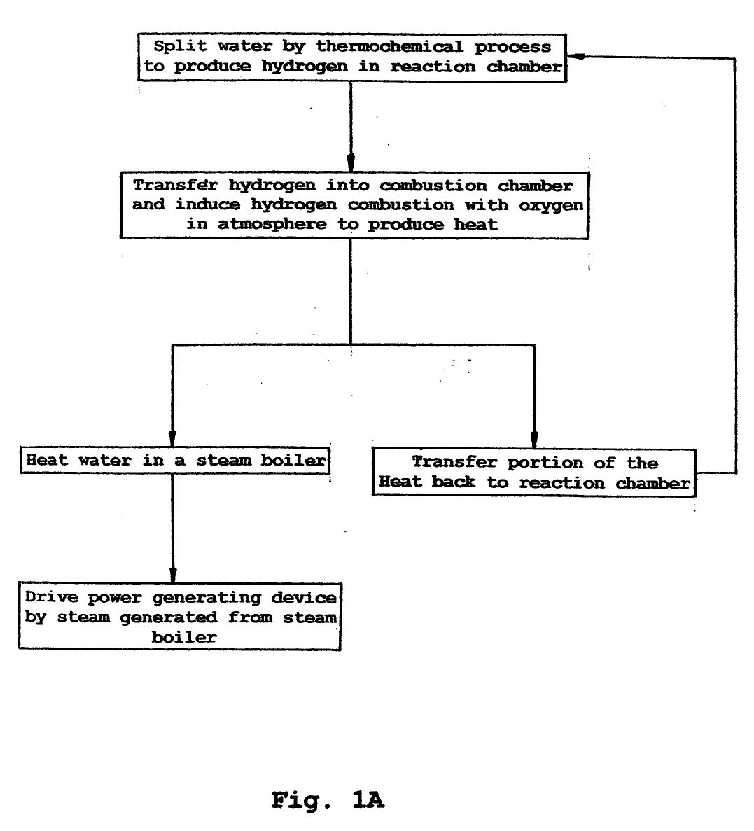

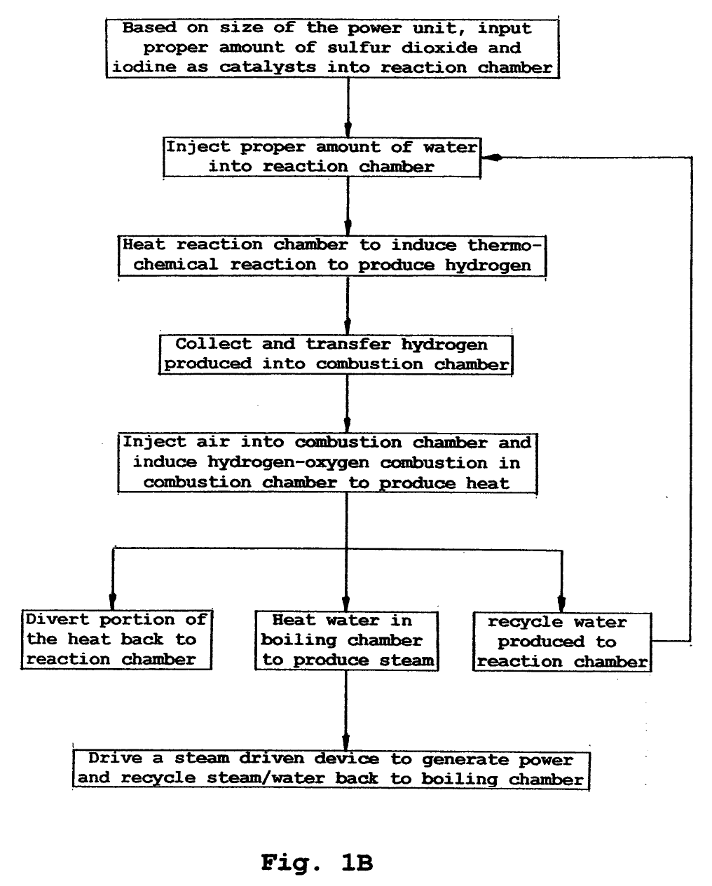

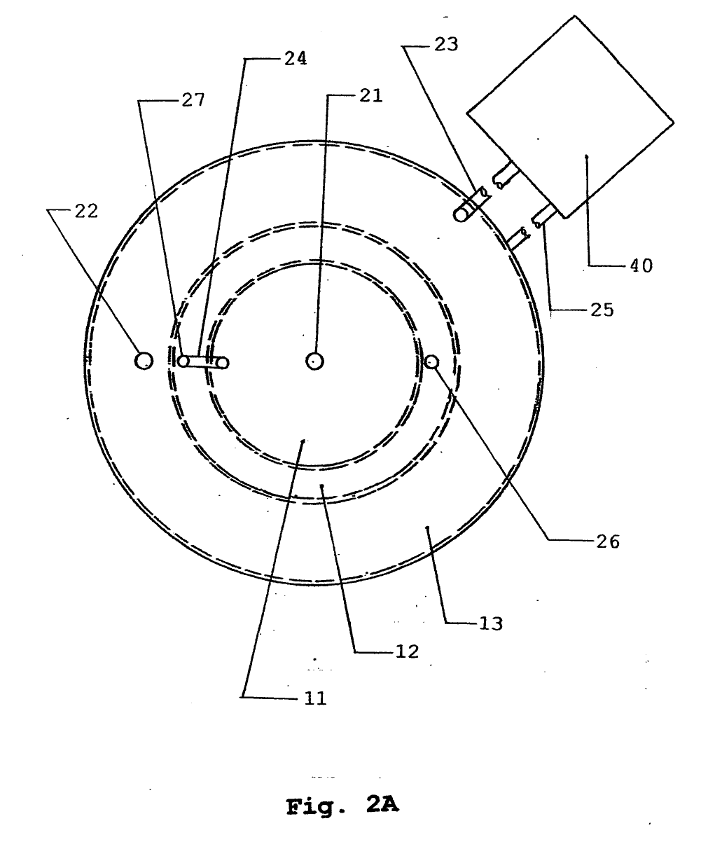

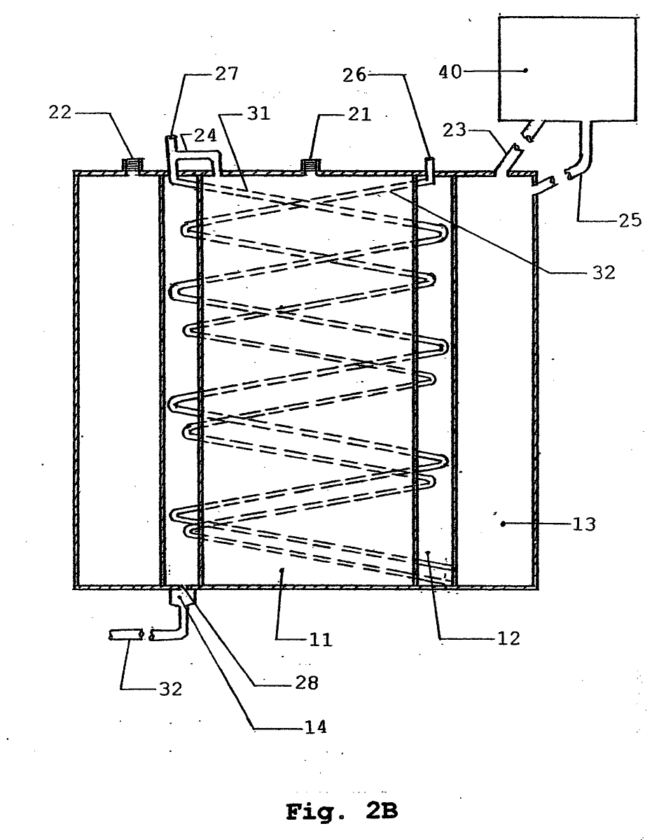

Referring to FIGS. 1A, 2A, and 2B of the drawings, a process of power generation according to a preferred embodiment of the present invention is illustrated, wherein the process comprises the following steps:
(1) Split the water in reaction chamber 11 by thermochemical reaction to produce hydrogen.
(2) Transfer hydrogen from reaction chamber 11 to combustion chamber 12 and intake air from air inlet 26 to combustion chamber 12 to induce instantaneous hydrogen-oxygen combustion.
(3) Conduct the heat generated in combustion chamber 12 to heat the water in boiling chamber 13 to produce steam. Portion of the heat generated in combustion chamber 12 is conducted to heat the reaction chamber 11 to sustain the continuous thermochemical reaction for hydrogen production.
(4) Transfer steam from boiling chamber 13 to conventional steam driven generator 40 to produce the power.
(5) Collect the water produced by hydrogen-oxygen combustion in water recovery pan 14 and recycle the water to reaction chamber 11; add additional water into reaction chamber 11 as required for continuous thermochemical reaction and hydrogen production.
(6) Repeat steps 2 through 5 for continuous power generation.

In step (1), based on the size requirements of steam driven power generator 40, the proper amount of sulfur dioxide (SO₂) and iodine (I) are placed in reaction chamber 11 to serve as the catalysts; proper amount of water is then added into reaction chamber 11. An initial amount of hydrogen and air are injected into combustion chamber 12 through initial hydrogen inlet 27 and air inlet 26 and distributed through hydrogen distribution coil 31 and air distribution coil 32 respectively, to induce instantaneous hydrogen-oxygen combustion in combustion chamber 12. The heat in combustion chamber 12 is then conducted to heat the ingredients in reaction chamber 11 to the temperature of 200° to 400° C. The thermochemical reaction in reaction chamber 11 is thus induced as follows:
I₂+SO₂+2H₂O→2HI+H₂SO₄
H₂SO₄→H₂O+SO₂+½O₂
2HI→I₂+H₂

Since the decomposition of H₂SO₄ into H₂O, SO₂ and ½O₂ does not occur until the temperature reaches 800° C., the present invention heats reaction chamber 11 to no more than 400° C. and thus eliminates the complicated process required for oxygen extraction in addition to conserving the heat required for thermochemical reaction. Instead, the present invention uses the oxygen in the atmosphere, which is free and abundant, to facilitate the hydrogen-oxygen combustion. The SO₂ and I₂ are retained in reaction chamber 11 as the catalysts for continuous hydrogen production.

In step (2), the hydrogen generated in reaction chamber 11 is transferred through hydrogen delivery tube 24 and distributed in combustion chamber 12 by hydrogen distribution coil 31. Simultaneously, air is injected through air inlet 26 and circulated in combustion chamber 12 by air distribution coil 32 to induce instantaneous combustion between hydrogen and oxygen to produce heat. The instantaneous combustion of hydrogen-oxygen proposed in the preferred embodiment of the present invention produces the high temperature blazing flame at about 2500° C., which is much higher than the around 1000° C. produced by fossil fuel burning process.

The combustion of the hydrogen-oxygen is illustrated in the following formula:
2H₂+O₂→2H₂O+Energy (heat)

At the bottom of combustion chamber 12, drain hole 28 and water recovery pan 14 are provided to recover the water produced by the hydrogen-oxygen combustion. The water collected in water recovery pan 14 is recycled back to reaction chamber 11 to reduce the water consumption.

In step (3), reaction chamber 11, combustion chamber 12, and boiling chamber 13 are arranged in such a manner that the heat produced in combustion chamber 12 can be used to heat both reaction chamber 11 and boiling chamber 13. The heat conducted to reaction chamber 11 sustains the thermochemical reaction for continuous hydrogen production. The heat conducted to boiling chamber 13 is used to generate steam for steam driven generator 40. The water required in the boiling chamber can be injected through water inlet 22. Water/steam collected from steam generator 40 is recycled to boiling chamber 13 through water/steam recycle tube 25.

In step (4), steam produced in boiling chamber 13 is guided to steam driven power generator 40 through steam outlet 23 to produce the electricity or mechanical power.

According to the preferred embodiment of the present invention, the steam driven power generator 40 can be any existing conventional steam turbine or steam driven mechanical device. After going through the power generation in the generator 40, the steam/water may be recycled back to boiling chamber 13.

The combustion process between hydrogen and oxygen produce steam or water only. It emits neither environmentally harmful substances nor agents that corrode equipment. Therefore it requires no waste purging mechanism and expends no energy for waste treatment. As a result, the heat produced by the hydrogen-oxygen combustion in combustion chamber 12 will be completely utilized to heat the water in the boiling chamber 13 and to sustain thermochemical reaction in reaction chamber 11. The resulting water is collected in water recovery pan 14 and is recycled back to reaction chamber 11 to minimize water consumption.

Similarly, the only substance in the boiling chamber 13 is water. Upon being heated, the water changes its physical state to steam vapor. No harmful agents are produced. Since only steam is produced in boiling chamber 13 and only steam is guided into the steam driven power generator 40, neither boiling chamber 13 nor generator 40 will require a waste purging system or corrosion protection mechanism. The water/steam may be collected as the by-product of steam generator 40, and recycled back to boiling chamber 13 to minimize water consumption.

According to this preferred embodiment of the present invention, in order to withstand the heat produced by the blazing flame and the hot steam as well as acid produced in the chemical reaction, the walls in reaction chamber 11, combustion chamber 12 and boiling chamber 13 are all coated with porcelain enamel. Further more, hydrogen distribution coil 31 and air distribution coil 32 in combustion chamber 12 are made of perforated tubing that distributes the gases evenly throughout the entire combustion chamber 12. Both Hydrogen distribution coil 31 and air distribution coil 32 in combustion chamber 12 are coated with porcelain enamel to protect against the high temperatures.

### CONCLUSION, RAMIFICATIONS, AND SCOPE OF INVENTION

Thus one skilled in the art will understand that the embodiment of the present invention as shown in the drawings and described above provides an economical way of power generation without emitting the environmental and ecological harmful by-products.

It will thus be seen that the objects of the present invention have been fully and effectively accomplished. Its embodiments have been shown and described for the purposes of illustrating the functional and structural principles of the present invention and are subject to change without departure from such principles. Accordingly, the scope of the invention should be determined not by the embodiment illustrated, but by the appended claims and their legal equivalents.

1. A process of power generation, comprising the steps of:
(a) split the water to produce hydrogen through thermochemical process in reaction chamber;
(b) transfer and distribute said hydrogen in combustion chamber, while at the same time injecting the air, wherein the said hydrogen gas instantaneously combusts with the oxygen in the said air to generate heat in said combustion chamber;
(c) heat the water in the boiling chamber by said heat generated in said combustion chamber to produce the steam vapor for outputting as power source; simultaneously, heat the water and catalysts in said reaction chamber by said heat generated in said combustion chamber to sustain the said thermochemical reaction process in said reaction chamber to produce said hydrogen continuously.

2. The process, as recited in claim 1, wherein the step (a) further comprises the steps of:
(a-1) place proper amount of catalysts, iodine (I₂) and sulfur dioxide (SO₂), in said reaction chamber;
(a-2) intake proper amount of said water into said reaction chamber through said water inlet;
(a-3) mix said water and said catalysts in said reaction chamber;
(a-4) heat said water and said catalysts in said reaction chamber with said heat from said combustion chamber to produce said hydrogen;
(a-5) collect said hydrogen.

3. The process, as recited in claim 1, wherein the step (b) further comprises the steps of:
(b-1) transfer said hydrogen from said reaction chamber to said combustion chamber through hydrogen delivery tube and distribute said hydrogen in said combustion chamber by hydrogen distribution coil comprising of perforated tubing;
(b-2) intake said air to said combustion chamber through air inlet and distribute said air in said combustion chamber by air distribution coil comprising of perforated tubing;
(b-3) induce said instantaneous hydrogen-oxygen combustion in said combustion chamber to generate heat in said combustion chamber;
(b-4) collect and recycle the water produced in said combustion chamber for further use in said thermochemical hydrogen production process in said reaction chamber

4. The process, as recited in claim 1, wherein the step (c) further comprises the steps of:
(c-1) intake said water to said boiling chamber and said reaction chamber through separated water inlets;
(c-2) impart said heat generated in said combustion chamber to heat said water in said boiling chamber surrounding the said combustion chamber; also impart said heat generated in said combustion chamber to said reaction chamber surrounded by said combustion chamber;
(c-3) vaporize said water to form steam in said boiling chamber; also induce said thermochemical reaction in said reaction chamber to form the said hydrogen;
(c-4) output said vapor from said boiling chamber to said steam driven power generator; also output said hydrogen from said reaction chamber to said combustion chamber.

5. The process, as recited in claim 4, wherein said combustion chamber is a space defined and surrounded by said boiling chamber and said combustion chamber is formed around said reaction chamber, wherein said boiling chamber has a water inlet for intaking said water into said boiling chamber and a steam outlet for outputting said steam from said boiling chamber, wherein said reaction chamber has a water inlet for intaking said water into said reaction chamber and a hydrogen outlet for outputting said hydrogen.

6. The process as recited in claim 5, wherein said combustion chamber has a set of coil perforated tubing to evenly distribute said hydrogen in said combustion chamber and a separated set of coil perforated tubing to evenly distribute said air in said combustion chamber, wherein these said coil tubing are inter-layered to induce instantaneously said hydrogen-oxygen combustion throughout the entire said combustion chamber.

7. The process as recited in claim 6, wherein said hydrogen and oxygen distribution tubing are porcelain enamel coated to resist the high temperature.

8. The process, as recited in claim 1, wherein the raw material in said reaction chamber for said hydrogen production is water.

9. The process, as recited in claim 1, wherein the raw material in said boiling chamber for said steam production is water.

10. The process, as recited in claim 2, wherein in the step (a-1), said catalysts include iodine and sulfur dioxide.

11. The process, as recited in claim 2, wherein in the step (a-3), a ratio between said water to be splitted, said iodine and said sulfur dioxide is 2:1:1 by mole.

12. The process, as recited in claim 2, wherein in the step of (a-4), said water and said catalysts mix in said reaction chamber is to be heated to a temperature between 200° C. to 400° C.

13. The process, as recited in claim 11, wherein said iodine, said sulfur dioxide and a portion of the said water to be splitted are regenerated and retained in said reaction chamber.

14. The process, as recited in claim 1, after the step (c), further comprises a step of:
(d) drive a said steam driven power generating device to produce power by said steam transferring from said boiling chamber.

15. The process, as recited in claim 1, wherein the combustion agent, oxygen, for said hydrogen-oxygen combustion in said combustion chamber is taken from the air.
